(19) United States
(12) Patent Application Publication
(10) Pub. No.: US 2026/0029743 A1
(43) Pub. Date: Jan. 29, 2026

(54) ELECTROPHOTOGRAPHIC IMAGE-FORMING APPARATUS AND PROCESS CARTRIDGE

(71) Applicant: CANON KABUSHIKI KAISHA, Tokyo (JP)

(72) Inventors: YUICHI KIKUCHI, Shizuoka (JP); MASATSUGU HONGO, Shizuoka (JP); TAKUMI FURUKAWA, Shizuoka (JP); MOTOTERU GOTO, Shizuoka (JP); KENJI TAKASHIMA, Kanagawa (JP)

(21) Appl. No.: 19/341,759

(22) Filed: Sep. 26, 2025

Related U.S. Application Data
(63) Continuation of application No. PCT/JP2024/011572, filed on Mar. 25, 2024.

(30) Foreign Application Priority Data
Mar. 27, 2023 (JP) 2023-049904

(51) Int. Cl. G03G 21/00; G03G 21/18

(52) U.S. Cl. CPC G03G 21/0023; G03G 21/0029; G03G 21/1814

(57) ABSTRACT

An electrophotographic image-forming apparatus comprising an electrophotographic photoreceptor that serves as a member to be charged, a cleaning member that is in contact with a surface of the electrophotographic photoreceptor, and a plasma actuator. The plasma actuator is provided with a dielectric, a first electrode that is provided to a first surface of the dielectric, and a second electrode that is provided to the first electrode with the dielectric interposed therebetween. The plasma actuator generates an induced current from an edge of the first electrode along an exposed part of the first surface of the dielectric, the exposed part not being covered by the first electrode. The plasma actuator is disposed so as to be capable of directly supplying the induced current to the surface of the electrophotographic photoreceptor. The plasma actuator controls the electric potential of transfer residual toner on the surface of the electrophotographic photoreceptor.

### CROSS-REFERENCE TO RELATED APPLICATIONS

This application is a Continuation of International Patent Application No. PCT/JP2024/011572, filed Mar. 25, 2024, which claims the benefit of Japanese Patent Application No. 2023-049904, filed Mar. 27, 2023, both of which are hereby incorporated by reference herein in their entirety.

### BACKGROUND

### Field of the Technology

The present disclosure is directed to an electrophotographic image forming apparatus and a process cartridge.

### Description of the Related Art

An electrophotographic image forming apparatus (hereinafter also referred to as an “electrophotographic apparatus”) includes various cleaning members for removing toner and externally added agents remaining on an image bearing member after transfer of a toner image from the image bearing member, such as a photosensitive member, onto a transfer target, such as a sheet or an intermediate transfer member.

With the advancement of image quality in electrophotographic apparatuses in recent years, toner particles have become smaller and more spherical, making it increasingly difficult to retain residual toner on the image bearing member by cleaning members, and consequently various cleaning members are required to have higher cleaning performance. Furthermore, with the prolonged service life of electrophotographic apparatuses, there has been a demand for so-called light-pressure cleaning, which uses cleaning members with low contact pressure for the purpose of suppressing wear of drums and cleaning members during long-term use and reducing the load on photosensitive drum motors.

Japanese Patent Laid-Open No. 2016-014740 discloses, as a member, a cleaning blade having a polyurethane elastomer for cleaning residual transfer toner on a photosensitive drum. Japanese Patent Laid-Open No. H11-202597 discloses a cleaning blade having a conductive portion and serving also as a charging member.

The inventors conducted a durability evaluation of the cleaning members over a long period disclosed in Japanese Patent Laid-Open No. 2016-014740 and Japanese Patent Laid-Open No. H11-202597, in an electrophotographic process of light-pressure cleaning.

In general, in an electrophotographic image forming process, the polarity of the voltage applied by the transfer roller is opposite to the potential induced on the surface of the photosensitive drum by the voltage applied to the charging member. Substances to be cleaned, such as toner failed to be transferred to paper or an intermediate transfer member (hereinafter also referred to as “residual transfer toner”), paper dust, and filler, acquire a polarity opposite to that of the photosensitive drum surface due to discharge from the transfer roller. For this reason, the substances to be cleaned may adhere strongly to the surface of the photosensitive drum due to electrostatic attraction, making it difficult to remove the substances with light pressure.

The cleaning blade according to Japanese Patent Laid-Open No. 2016-014740 achieves improved cleaning performance of the cleaning blade by allowing control of the contact pressure to the photosensitive drum through adjustment of the chemical structure of the polyurethane elastomer contained in the elastic portion. According to the study conducted by the inventors, in the cleaning blade disclosed in Japanese Patent Laid-Open No. 2016-014740, under conditions of long-term use and a light-pressure cleaning configuration, toner and externally added agents may pass through the blade, resulting in contamination of the charging member, and the contaminated area may appear as streaks in the image.

Furthermore, in the charging and cleaning blade having a conductive portion, as disclosed in Japanese Patent Laid-Open No. H11-202597, it is difficult to suppress the passage of contaminants, i.e., toner and externally added agents. through the blade over long-term use. As a result of the passage of contaminants, the toner and externally added agents may adhere to the conductive portion responsible for charging, due to electrostatic attraction, and the contaminated area may interfere with discharge, potentially causing image defects.

### SUMMARY

In view of the foregoing, at least one aspect of the present disclosure is directed to providing an electrophotographic image forming apparatus that exhibits stably excellent cleaning performance on the surface of a photosensitive drum over a long period of time. Furthermore, at least one aspect of the present disclosure is directed to providing a process cartridge that exhibits excellent cleaning performance on the surface of a photosensitive drum over a long period.

An electrophotographic image forming apparatus according to at least one aspect of the present disclosure includes: an electrophotographic photosensitive member serving as a charge-receiving member; a cleaning member in contact with a surface of the electrophotographic photosensitive member; and a plasma actuator,
the plasma actuator includes:
a dielectric;
a first electrode provided on a first surface of the dielectric; and
a second electrode provided opposed to the first electrode across the dielectric,
application of an AC voltage between the first and second electrodes causes the plasma actuator to generate an induced flow from an edge of the first electrode along an exposed portion of the first surface of the dielectric, the exposed portion being a portion not covered with the first electrode, and
the plasma actuator is disposed to be capable of directly supplying the induced flow to the surface of the electrophotographic photosensitive member to control a potential of residual transfer toner on the surface of the electrophotographic photosensitive member.

A process cartridge removably mountable to an electrophotographic image forming apparatus according to at least one aspect of the present disclosure includes:
an electrophotographic photosensitive member; a cleaning member in contact with a surface of the electrophotographic photosensitive member; and a plasma actuator,
the plasma actuator includes:
a dielectric;
a first electrode provided on a first surface of the dielectric; and
a second electrode provided opposed to the first electrode across the dielectric,
application of an AC voltage between the first and second electrodes causes the plasma actuator to generate an induced flow from an edge of the first electrode along an exposed portion of the first surface of the dielectric, the exposed portion being a portion not covered with the first electrode, and
the plasma actuator is provided to be capable of directly supplying the induced flow to the surface of the electrophotographic photosensitive member to control a potential of residual transfer toner on the surface of the electrophotographic photosensitive member.

Features of the present disclosure will become apparent from the following description of embodiments with reference to the attached drawings.

### BRIEF DESCRIPTION OF THE DRAWINGS

FIGS. 1A to 1C are schematic views of a plasma actuator and a cleaning member according to one aspect of the present disclosure;

FIG. 2 is a schematic view of an exemplary configuration of the plasma actuator;

FIG. 3 is a schematic view of an exemplary configuration of the plasma actuator;

FIG. 4 is a view illustrating the charging of contaminants due to an induced flow;

FIGS. 5A and 5B are views illustrating the overlap between a first electrode and a second electrode;

FIGS. 6A to 6D are views illustrating suppression of electric field concentration by the overlap.

FIGS. 7A to 7C are views illustrating irregularities at the edge of the first electrode;

FIGS. 8A to 8D are views illustrating the arrangement of the plasma actuator and the cleaning member;

FIG. 9 is a view of a general structure of a process cartridge;

FIG. 10 is a view of a general structure of an electrophotographic image forming apparatus;

FIG. 11 is a view illustrating a method for measuring wind velocity by PIV;

FIG. 12 is a view of an example in which a plasma actuator is incorporated into a cleaning member; and

FIG. 13 is a view of an example in which an induced flow is not directly supplied to the surface of a photosensitive drum.

### DESCRIPTION OF THE EMBODIMENTS

Hereinafter, embodiments for carrying out the disclosure will be specifically described with reference to the drawings. However, it should be understood that the dimensions, materials, shapes, and relative arrangements of the components described in the embodiments should be modified as appropriate depending on the configuration of the members to which the disclosure is applied and various other conditions. In other words, it is not intended that the scope of this disclosure is limited to the embodiments described below.

In this disclosure, numerical ranges expressed as “from XX to YY” or “XX to YY” shall be understood to include the lower and upper limits, which constitute the endpoints of the range, unless otherwise specified. When numerical ranges are described stepwise, the lower and upper limits of the respective ranges may be combined arbitrarily.

In an electrophotographic apparatus, toner and external additives remaining on the photosensitive drum after the transfer process, as well as paper dust and fillers originating from the printing paper and transferred to the drum (hereinafter collectively referred to as contaminants), are charged by discharge during the transfer process and adhere to the surface of the photosensitive drum due to electrostatic attraction.

The inventors have recognized that, since the surface of the photosensitive drum often retains a surface potential of 100 V or more even after the transfer process, the electrostatic attraction between the contaminants and the drum remains strong, making it difficult to scrape off the contaminants with a cleaning member in a light-pressure cleaning system.

The inventors have found, as a result of their study, that excellent cleaning performance can be maintained over a long period even under light contact pressure of the cleaning member against the electrophotographic photosensitive member, by irradiating the residual transfer toner, which is to be removed by the cleaning member, with a charged induced flow to control its potential.

Specifically, an electrophotographic image forming apparatus according to at least one aspect of the disclosure includes an electrophotographic photosensitive member serving as a charge-receiving member, a cleaning member in contact with a surface of the electrophotographic photosensitive member, and a plasma actuator, and
the plasma actuator includes:
a dielectric;
a first electrode provided on a first surface of the dielectric; and
a second electrode provided opposed to the first electrode across the dielectric,
application of an AC voltage between the first and second electrodes causes the plasma actuator to generate an induced flow from an edge of the first electrode along an exposed portion of the first surface of the dielectric, the exposed portion being a portion not covered with the first electrode, and
the plasma actuator is provided to be capable of directly supplying the induced flow to the surface of the electrophotographic photosensitive member to control a potential of residual transfer toner on the surface of the electrophotographic photosensitive member.

Here, the control of the potential of the residual transfer toner includes at least one selected from the group consisting of neutralizing the residual transfer toner by the induced flow, and charging the residual transfer toner by the induced flow to a polarity identical to that of the surface of the electrophotographic photosensitive member. Hereinafter, at least one selected from the group consisting of neutralizing the residual transfer toner by the induced flow, and charging the residual transfer toner by the induced flow to a polarity identical to that of the surface of the electrophotographic photosensitive member may be simply referred to as “neutralization and/or charging.”

The inventors consider that the reason why the above-described electrophotographic apparatus was able to significantly improve cleaning performance under low pressure is as follows.

The jet-like induced flow generated from the plasma actuator contains a mixture of positive, negative, and neutral charges, and can therefore cancel out either the positive or negative polarity of a target object exposed to the flow, thereby enabling static neutralization. In the electrophotographic apparatus, the induced flow is supplied to the contaminant, such as residual toner remaining after the transfer, before reaching the contact portion between the cleaning member and the electrophotographic photosensitive member. Therefore, the induced flow reduces the amount of charge on the contaminants present on the photosensitive drum, thereby significantly decreasing the electrostatic attraction between the contaminants and the drum, and consequently suppressing their adhesion therebetween. In addition, since the induced flow from the plasma actuator is also supplied to the photosensitive drum, the surface of the photosensitive drum is simultaneously neutralized, further reducing the electrostatic attraction between the contaminants and the photosensitive drum.

Furthermore, the jet-like induced flow moves and rolls the contaminants on the drum, thereby allowing the contaminants to be scattered across the drum surface. In addition, by physically moving and rolling the contaminants with the induced flow, surfaces of the contaminants facing the drum surface can also be exposed to the induced flow, enabling most of the surface charge to be neutralized.

For the reasons described above, in an electrophotographic apparatus provided with a plasma actuator and a cleaning member, the electrostatic attraction between contaminants and the photosensitive drum can be significantly reduced, thereby improving the ability of the cleaning member to block the contaminants. As a result, it is considered possible to improve the long-term cleaning performance under light contact pressure.

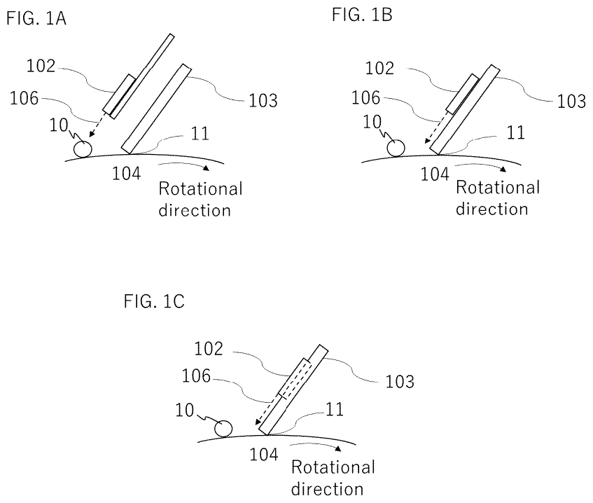

Hereinafter, an electrophotographic apparatus 101 according to one embodiment of the present disclosure will be described with reference to FIGS. 1A to 1C. FIGS. 1A to 1C are schematic diagrams illustrating the surface of a photosensitive drum 104 serving as an electrophotographic photosensitive member, a cleaning member 103, and a plasma actuator (plasma generator) 102.

As shown in FIG. 1A, the electrophotographic apparatus includes a photosensitive drum 104 serving as a charge-receiving member, a cleaning member 103 in contact with the surface of the photosensitive drum 104, and a plasma actuator 102. As shown in FIG. 1B, the cleaning member 103 and the plasma actuator 102 may be integrally formed. Alternatively, as shown in FIG. 1C, the plasma actuator 102 may be incorporated into the cleaning member 103. The rotational direction indicates the rotational direction of the photosensitive drum 104.

In FIGS. 1A to 1C, the contaminant 10 present on the photosensitive drum 104 enters the contact portion 11 between the cleaning member 103 and the photosensitive drum 104 and is cleaned off by the cleaning member 103. Furthermore, the plasma actuator 102 is arranged so that it can supply an induced flow 106 containing electric charge to the contaminant 10 prior to its entry into the contact portion 11.

As a result, the plasma actuator can exert the effects of neutralizing and/or charging the contaminant 10 entering the cleaning member 103 and physically rolling the contaminant 10. As a result, electrostatic attraction to the surface of the photosensitive drum is reduced, and cleaning performance by the cleaning member 103 can be improved.

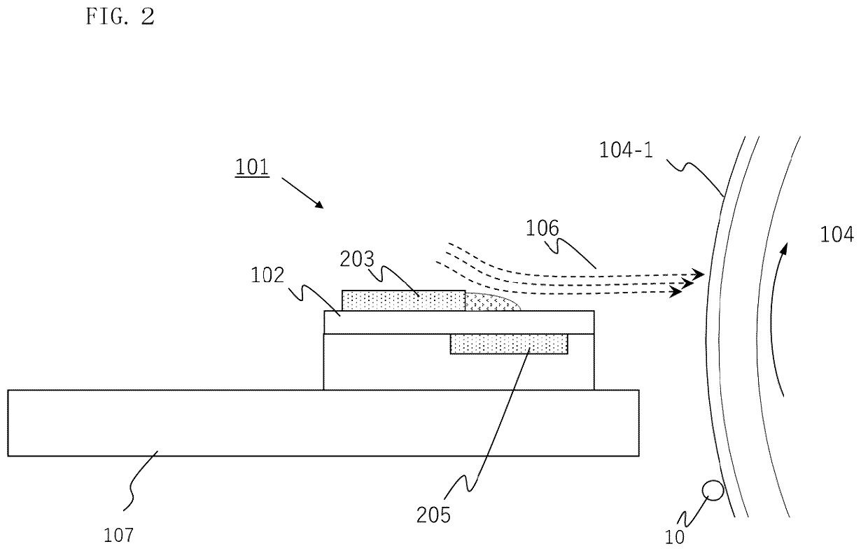

FIG. 2 specifically illustrates an example of an electrophotographic apparatus. The electrophotographic apparatus 101 includes the plasma actuator 102 and the photosensitive drum 104. In FIG. 2, the reference numeral 10 denotes a contaminant (residual transfer toner) remaining on the surface of a photosensitive drum 104-1, and reference numeral 106 denotes an induced flow.

### Plasma Actuator

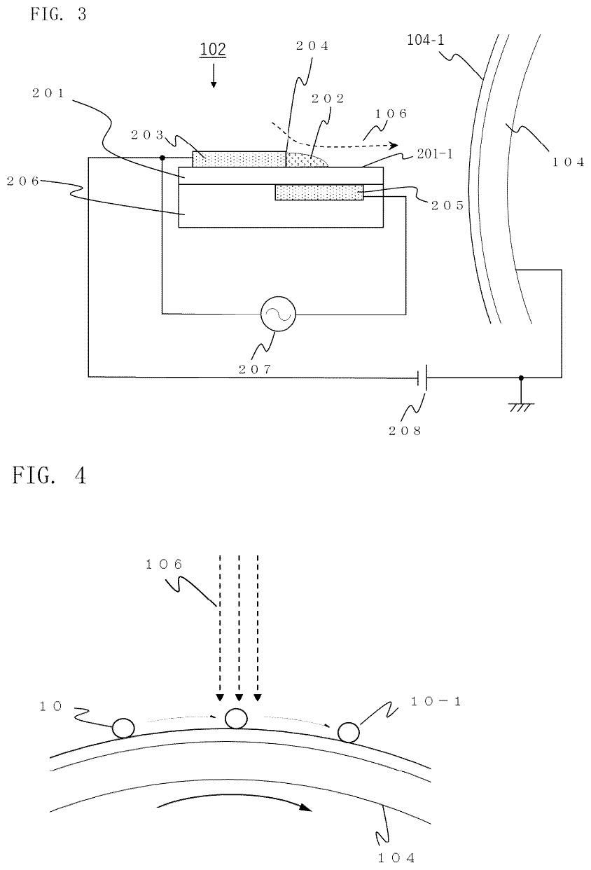

FIG. 3 shows a cross-sectional structure of the plasma actuator 102 according to one aspect. The plasma actuator 102 includes a first electrode 203 on one surface (hereinafter also referred to as a “first surface”) of a dielectric 201. The plasma actuator 102 also includes a second electrode 205 provided across the dielectric 201 with respect to the first electrode 203. The plasma actuator 102 may have the second electrode 205 provided on the surface (hereinafter also referred to as a “second surface”) opposite to the first surface. The plasma actuator 102 is a so-called dielectric barrier discharge (DBD) plasma actuator. (Hereinafter, simply referred to as “DBD-PA” in some cases).

In FIG. 2, the reference numeral 206 denotes a dielectric substrate, the reference numeral 207 denotes an AC power source, and the reference numeral 208 denotes a DC power source. The dielectric substrate 206 is a substrate for embedding the second electrode 205 in the thickness direction of the plasma actuator so as not to generate an induced flow from the end surface of the second electrode. That is, the first and second electrodes 203 and 205 may be provided with the dielectric 201 interposed therebetween, and the second electrode 205 may be embedded in the dielectric 201.

In the plasma actuator 102, the first electrode 203 and the second electrode 205 arranged with the dielectric 201 therebetween for example, to be shifted obliquely from each other. By applying an AC voltage between these electrodes (between both electrodes), plasma 202 is generated from the first electrode 203 toward the second electrode 205. The induced flow 106, which is a jet flow of plasma (surface plasma) 202, is induced from the edge portion 204 of the first electrode 203 along the exposed portion 201-1 of the first surface of the dielectric 201 (the portion not covered with the first electrode).

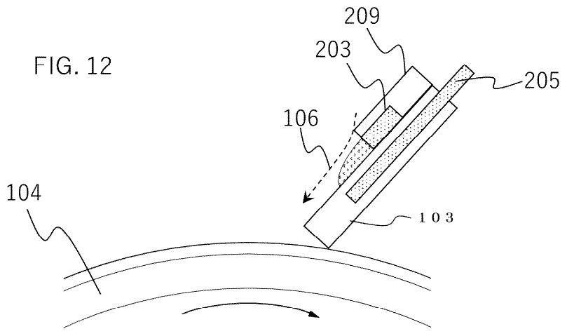

By arranging the first and second electrodes 203 and 205 arranged with the dielectric 201 interposed therebetween to be obliquely shifted from each other, the induced flow 106 can be easily supplied in a desired direction, and the cleaning performance can be further improved. Even if the first and second electrodes 203 and 205 are not arranged obliquely from each other, for example, as shown in FIG. 12, which will be described later, the induced flow can be prevented from being generated in directions other than the desired direction by providing the dielectric.

The plasma actuator 102 is provided, for example as shown in FIG. 2, on a base member 107 so that the induced flow 106 is supplied to the surface 104-1 of the photosensitive drum. The base member 107 is not particularly limited and may be made of any known material such as ABS (acrylonitrile-butadiene-styrene copolymer) resin. As shown in FIG. 1B, the plasma actuator 102 may be provided on the cleaning member 103 so that the induced flow 106 is supplied to the surface 104-1 of the photosensitive drum.

That is, in such an arrangement, the induced flow 106 carrying electric charge from the plasma actuator 102 is directly supplied to the surface of the photosensitive drum. As a result, both the surface of the photosensitive drum and contaminants remaining on the surface can be neutralized and/or charged.

The induced flow 106 flows in a jet-like manner, generated by surface plasma along the exposed portion 201-1 of the first surface of the dielectric 201, starting from the edge portion 204 of the first electrode 203, namely, in a direction along the exposed portion 201-1 of the first surface of the dielectric from the edge portion 204 of the first electrode 203. This induced flow is a gas flow having a velocity of several meters to several tens of meters per second.

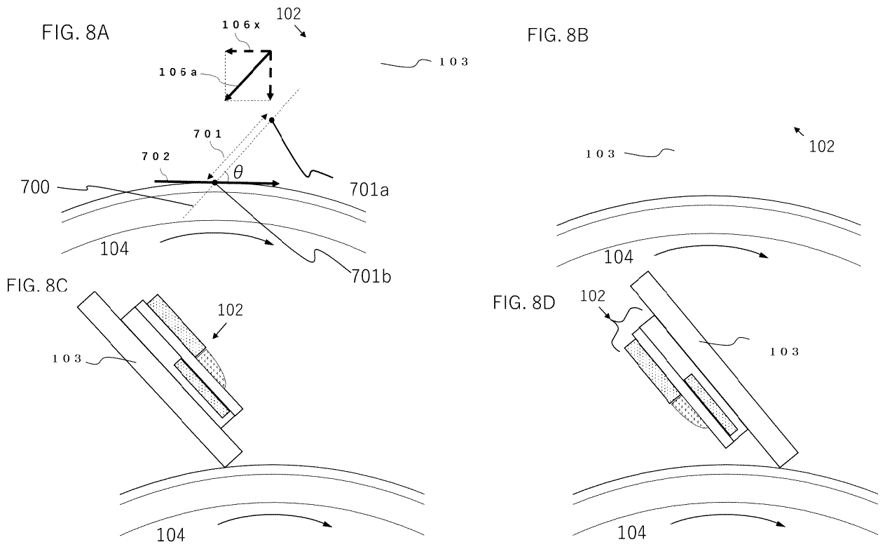

The velocity of the induced flow at a position 1.0 mm away from the tip in the supply direction of the induced flow from the plasma actuator, as measured by particle image velocimetry, is preferably 0.10 m/sec to 1.00 m/sec, more preferably 0.15 m/sec to 1.00 m/sec, still more preferably 0.15 m/sec to 0.60 m/sec, and most preferably 0.20 m/sec to 0.40 m/sec. The position 1.0 mm away from the tip refers to a position, as shown in FIG. 8A, that lies 1.0 mm in the supply direction of the induced flow from the tip 701a on the second electrode side along the extension of a line (line 700) in the direction along the exposed portion 201-1 of the first surface of the dielectric from the edge portion of the first electrode of the plasma actuator. Since the velocity falls within the above range, an induced flow more sufficient to neutralize and/or charge the contaminants or the photosensitive drum can be supplied.

Simultaneously with the generation of the induced flow 106, a suction flow is also generated toward the first electrode. Accordingly, due to the combined effect of the jet-like flow by the surface plasma 202 and the suction flow of air, the induced flow 106 containing electric charge is generated from the edge portion 204 of the first electrode 203 along the surface of the dielectric 201. The plasma actuator 102 is arranged such that the induced flow 106 is directly supplied to the surface 104-1 of the photosensitive drum, and simultaneously to the contaminant present on the photosensitive drum.

The induced flow 106 contains positively and negatively charged particles generated by ionization due to discharge of the plasma actuator, as well as electrically neutral particles. As described above, it is considered that these mixed charges can eliminate the charge from the photosensitive drum and the contamination.

It is also possible to charge the photosensitive drum 104 and the contaminant 10 to a desired polarity by an electric field formed between the plasma actuator 102 and the photosensitive drum by a DC voltage. For example, a positive or negative DC voltage may be superimposed between the first electrode 203 and the photosensitive drum 104. Among the positive and negative charges generated by ionization due to discharge, the charges can be preferentially supplied to the surface 104-1 of the photosensitive drum and the contaminant 10 in accordance with the electric field produced by the DC voltage.

In other words, the charge supplied to the photosensitive drum 104 can be controlled by superimposing an AC voltage and a DC voltage, and the surface 104-1 of the photosensitive drum and the contaminant 10 on the surface can be charged. As the level of the DC voltage applied increases, more charges having the same polarity as the applied voltage are supplied to the surface 104-1 of the photosensitive drum body, thereby improving the charging performance.

As shown in FIG. 4, the contaminant 10 having electric charge with a polarity opposite to that of the transfer bias applied by the transfer roller is conveyed in accordance with the rotation of the photosensitive drum 104 and receives the induced flow 106 containing electric charge. The contaminant 10-1, having received the induced flow, is charged to the same polarity as the photosensitive drum 104 by the charges contained in the induced flow. By charging both the contaminant 10-1 and the photosensitive drum 104 to the same polarity, the electrostatic attraction between the contaminant 10-1 and the photosensitive drum 104 is further reduced, which allows the cleaning performance by the cleaning member 103 to be improved.

Accordingly, by supplying the induced flow 106 containing electric charge, generated from the plasma actuator 102, to contaminants entering the cleaning member, the contaminants can be neutralized or charged to the same polarity as the photosensitive drum, and can be physically moved by the induced flow. As a result, the electrostatic attraction between the surface of the photosensitive drum and the contaminants is reduced, thereby improving light-pressure cleaning performance.

Whether the contaminants, such as residual transfer toner, are neutralized or charged to the same polarity as the photosensitive drum can be determined, for example, by measuring the surface potential or charge amount of the residual transfer toner present on the photosensitive drum. Specifically, by using a quantification method for the charge distribution of a residual transfer toner group, which will be described later, it is possible to determine whether the residual transfer toner has been neutralized. More specifically, a possible method includes checking, before and after irradiation of the residual transfer toner with the induced flow 106, from among toner having the same polarity as the voltage applied to the transfer member (hereinafter also referred to as polarity A), the proportion of toner particles whose polarity has reversed to polarity opposite to the polarity A.

While the specific measurement method will be described later, it is preferable that the ratio of change Δ in the number of toner particles whose polarity has reversed before and after the irradiation with the induced flow be 50% or more. More preferably, the ratio of change Δ is 80% to 100%. When the ratio falls within this range, the electrostatic attraction with the photosensitive drum can be suppressed, and cleaning performance can be improved.

The amount of residual transfer toner, which serves as a reference when determining a change in polarity, may be measured, for example, under transfer process conditions that yield a coverage value of 5% obtained by the following measurement method, and the change in the polarity of the residual transfer toner caused by the plasma actuator may then be determined. Specifically, the coverage value can be measured, for example, by stopping the printing operation while a solid black image is being printed, removing the residual transfer toner adhering between the contact portion of the transfer member and the contact portion of the charging member on the photosensitive drum using tape (product name: CT18, manufactured by Nichiban), and affixing the toner to a sheet of print paper. Then, the reflectance of the portion where the residual transfer toner has adhered is measured using a reflection densitometer (product name: TC-6DS/A, manufactured by Tokyo Denshoku Co., Ltd.), and the amount (%) of decrease in the reflectance with respect to the reflectance of the portion of the tape where no residual transfer toner is adhered is measured. This measured value is defined as the coverage value.

### Arrangement of Electrodes

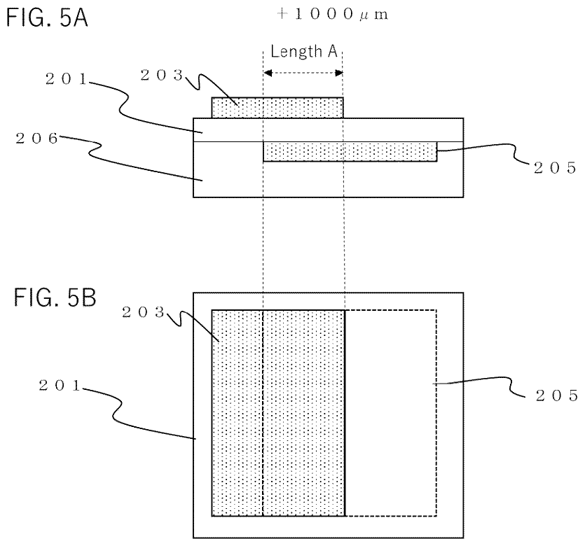

The arrangement of electrodes will now be described with reference to FIGS. 5A and 5B. FIG. 5A is a cross-sectional view taken through the dielectric, the first electrode 203, and the second electrode 205. FIG. 5B is a perspective view of the plasma actuator from the surface side of the first electrode. The first electrode 203 and the second electrode 205 arranged obliquely to each other are preferably arranged such that the edge of the first electrode is present at the formation portion of the second electrode with the dielectric interposed therebetween when viewed from the upper side of the cross-sectional view. In other words, as shown in FIG. 5B, it is preferable that at least a portion of the edge of the first electrode overlaps with the second electrode when the plasma actuator is viewed from the surface side of the first electrode. In this way, the first and second electrodes are preferably provided so as to overlap each other with the dielectric interposed therebetween.

When the first and second electrodes are arranged to overlap with each other with the dielectric interposed therebetween, the distance between the electrodes may be minimized and the electric field strength may be maximized, allowing a strong induced flow to be generated. In this case, it is preferable to prevent dielectric breakdown at the overlapping portion between the first and second electrodes with the dielectric interposed therebetween when a voltage is applied.

If an edge of the second electrode is exposed, plasma may also be generated from the edge of the second electrode, and this may result in an induced flow in a direction opposite to that of the induced flow 106 originating from the first electrode. It is preferable to avoid directing induced flow to regions other than the surface of the charge-receiving member. Therefore, the generation of induced flow originating from the second electrode is preferably prevented. To this end, as shown in FIGS. 3 and 5A, the second electrode 205 is preferably covered with a dielectric such as the dielectric substrate 206, or embedded in the dielectric 201, in order to prevent plasma generation from the edge portion of the second electrode.

From the viewpoint of uniformly neutralizing or charging contaminants, when the plasma actuator is viewed from the side of the first electrode, the induced flow is preferably generated from one side of the first electrode. For example, it is preferable to generate the induced flow in a single direction toward the surface of the photosensitive member from one side of the first electrode that faces the surface of the photosensitive member. To prevent the induced flow from being generated from sides of the first electrode other than the above-mentioned side, the other sides of the first electrode may be covered with a dielectric. Additionally, when the plasma actuator is viewed from the side of the first electrode, a side adjacent to the side from which the induced flow is generated and a side of the second electrode may be aligned along the same straight line in a view from the side of the first electrode (see FIG. 5B).

FIGS. 5A and 5B are views illustrating the overlapping between the first electrode 203 and the second electrode 205 of the plasma actuator 102. The views are cross-sectional views of the plasma actuator.

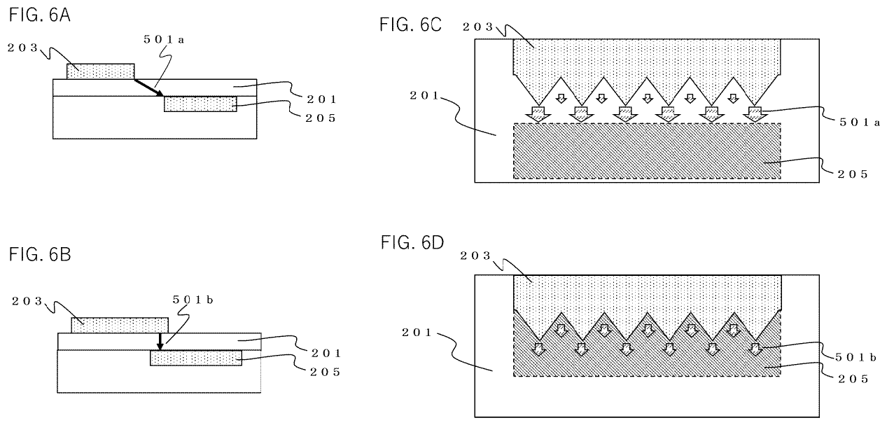

The length of the overlapping portion between the edge of the first electrode and the edge of the second electrode is referred to as length A, where the overlapping length is defined as a positive value. In other words, when the plasma actuator is viewed from the surface side of the first electrode (FIG. 6B), the length A between the edge of the first electrode and the edge of the second electrode that form the overlapping portion is preferably in the range of 0 μm to 1000 μm, more preferably 80 μm to 1000 μm, even more preferably 100 μm to 1000 μm, and most preferably 100 μm to 700 μm.

The first and second electrodes are overlapped so that the electric field concentration caused by the protrusion shape of the electrode edges, which will be described later, can be suppressed. As a result, streaks in the image due to uneven discharge and uneven contaminant adhesion caused by non-uniformity in the induced flow can be reduced.

The protruding shape of the edge of the electrode will be described. FIGS. 6A to 6D are cross-sectional and top views of the plasma actuator. When the two electrodes are spaced apart and not overlapping as shown in FIG. 6A, the electric field tends to concentrate at the apex of the protruding shape at the edge of the first electrode, which may result in discharge irregularities and variations in the strength of the induced flow in the longitudinal direction (501a).

Meanwhile, when the two electrodes are overlapped as shown in FIGS. 6B and 6D, the electric field strength formed between the electrodes is determined by the thickness of the dielectric, which helps alleviate discharge irregularities in the longitudinal direction (501b). In addition, local electric field concentration at the protruding portion can be reduced, dielectric breakdown can be suppressed even when the distance between the two electrodes is small. When the electrodes have a protruding shape, the length A refers to the distance between the edge of the first electrode that is closest to the second electrode and the portion of the edge of the second electrode that is closest to the first electrode.

### Thickness of Electrodes

There is no particular limitation on the thickness of the electrodes, and both the first and second electrodes may have a thickness in the range of 10 μm to 1000 μm. When the thickness is 10 μm or more, the resistance of the electrode itself decreases, making it easier for plasma to be generated. When the thickness is 1000 μm or less, electric field concentration is more likely to occur, which makes plasma generation easier.

### Material of Electrodes

The materials of the first and second electrodes are not particularly limited, as long as they are highly conductive and do not interfere with the effects of the present disclosure. Examples of the materials include metals such as copper, aluminum, stainless steel, gold, silver, and platinum, metals plated with or vapor-deposited with another material, conductive carbon materials such as carbon black, graphite, and carbon nanotubes, and composite materials formed by mixing such conductive carbon materials with resins or the like. The materials of the first and second electrodes may be the same or different.

Among these, in view of avoiding corrosion of the electrode and achieving uniform discharge, the material of the first electrode is preferably aluminum, stainless steel, or silver. For the same reason, the material of the second electrode is also preferably aluminum, stainless steel, or silver.

### Shape of Electrodes

Furthermore, the shapes of the first and second electrodes may be selected from plate-like, wire-like, or needle-like forms, as long as they do not interfere with the effects of the present disclosure. The shape of the first electrode is preferably plate-like. The shape of the second electrode is also preferably plate-like.

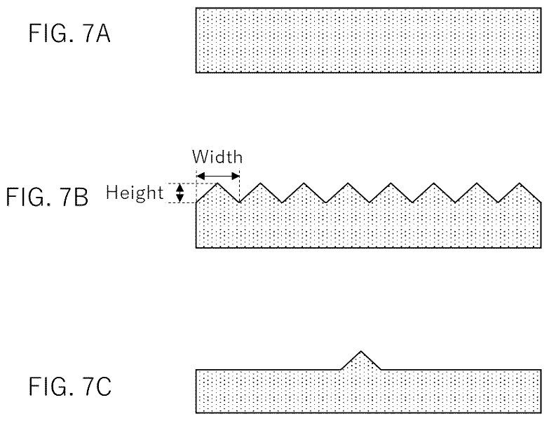

FIGS. 7A to 7C schematically illustrate non-limiting examples of electrode shapes.

The edge of the first electrode and the edge of the second electrode are preferably linear or substantially linear. The term substantially linear is not limited to an exactly straight line, but may include, for example, shapes that are linear to the extent that they allow uniform discharge and suppression of electric field concentration, permitting slight irregularities or unevenness. Specifically, as shown in FIG. 7A, it is preferred to have a linear shape without unevenness. When the edges of the electrodes are linear, the discharge becomes uniform, allowing charges to be supplied uniformly in the longitudinal direction. Since the charged induced flow is also supplied to the surface of the photosensitive drum, the uniform discharge in the longitudinal direction results in a uniform surface potential on the photosensitive drum, which makes it easier to suppress streaked images. Furthermore, the non-uniformity of the induced flow supplied to the contaminant in the longitudinal direction is reduced, so that the neutralizing and dispersing effects on the contaminant also become uniform.

Specifically, in order to suppress electric field concentration at the edge of the first electrode and the edge of the second electrode (preferably the edge of the first electrode), the maximum height of the protrusions is preferably in the range of 0 μm to 40 μm, and the width is preferably in the range of 0 μm to 40 μm. More preferably, the height is in the range of 0 μm to 25 μm, and the width is in the range of 0 μm to 25 μm. The height of the protrusion may be regarded as the length in the direction of the length A. The width of the protrusion may be regarded as the length in a direction perpendicular to the direction of the length A and along the surface of the dielectric. The protrusion shape is not limited to a sawtooth shape as shown in FIGS. 7A and 7B. The protrusion may include those regularly present along the edge as shown in FIG. 7B, and those having at least one protrusion along the edge as shown in FIG. 7C.

To reduce the maximum height and width of the protrusions to within the above-described ranges, a possible method is to print the electrode using a masking member that has been polished or cut with a sharp blade so that the edge shape has no irregularities in the longitudinal direction, when forming the electrode by a process such as screen printing using a liquid or metal vapor deposition with masking. Additionally, a metal sheet or a razor that has been polished or cut with a sharp blade may be used to ensure that the edge shape has no irregularities in the longitudinal direction.

As described above, the electric field concentration caused by the protrusions on the edge of the first electrode can be reduced by controlling the amount of overlap between the first and second electrodes. In addition, since this also suppresses electric field concentration at the protrusions, dielectric breakdown between the two electrodes can be prevented, which enables more stable discharge within the above-described range of overlap.

Examples of methods for forming electrodes include bonding metal plates or foils, vapor deposition, and screen printing. To generate stable discharge and supply electric charges uniformly in the longitudinal direction to the charge-receiving member, it is preferable to use, as the electrode, a conductive tape or metal foil having a precisely formed edge shape, or a metal plate whose edge has been polished to a sharp point like a razor.

Examples of methods for measuring the shape of the electrode include observing the plasma actuator from the first electrode side using an optical microscope, laser microscope, electron microscope, digital camera, visual inspection, or a magnifying glass. In order to perform more accurate shape measurement, it is preferable to use a laser microscope or optical microscope equipped with dimensional measurement functions.

The height and width of the protrusions can be obtained, for example, in the following manner. First, an image of a step formed by the first electrode and the dielectric layer is captured using an optical microscope, a laser microscope, or a confocal microscope. Specifically, observation and determination are performed over the longitudinal direction within a field of view of 1000 μm×1000 μm using a laser microscope (product name: Color 3D Laser Microscope VK-8700, manufactured by Keyence Corporation). Two-dimensional image data are obtained by scanning with a laser in the X-Y plane within the field of view, and three-dimensional image data are obtained by further scanning in the Z direction (height direction) at intervals of 0.2 μm.

The three-dimensional data is acquired over the entire longitudinal direction of the first electrode, and using the length measurement function of the analysis software the comes with the laser microscope, the height and width as shown in FIG. 7B may be calculated from the resulting set of three-dimensional images. Note that, since the height of the protrusions has a higher sensitivity to electric field strength than the width, the protrusion with the greatest measured height among the protrusions is defined as the maximum protrusion.

### Applied Voltage

The voltage of the AC voltage applied between the first electrode 203 and the second electrode 205 of the plasma actuator is not particularly limited as long as it can cause plasm to be generated a in the plasma actuator. The voltage is preferably an AC voltage or a pulsed voltage. Further, the amplitude of the voltage is preferably 1 kV to 100 kV, more preferably 1 kV to 10 kV. Furthermore, the frequency of the voltage is preferably 1 kHz or more, and more preferably 5 kHz to 20 kHz.

When the voltage is an AC voltage, the waveform of the AC voltage is not particularly limited and may be a sine wave, a square wave, a triangular wave, or the like, but from the viewpoint of fast rise time of the voltage, it is preferably a square wave. The duty ratio of the voltage may also be appropriately selected, but it is preferable that the voltage have a fast rise time. Preferably, the voltage is applied such that the rise in voltage from the bottom to the peak of the amplitude of the waveform is 4,000,000 V/s or more.

It is also preferable that the value obtained by dividing the amplitude of the voltage applied between the first electrode 203 and the second electrode 205 by the film thickness of the dielectric 201 (i.e., voltage/thickness) be 10 kV/mm or more.

### DC Voltage

By superimposing a DC voltage, an induced flow carrying charges having a polarity biased toward the polarity opposite to that of the charged contaminant can be supplied. That is, it is preferable to apply a DC voltage between the first electrode of the plasma actuator and the electrophotographic photosensitive member. This preferably causes the surface of the electrophotographic photosensitive member and the residual transfer toner to be charged to the same polarity.

The DC voltage applied between the first electrode 203 of the plasma actuator and the photosensitive drum 104 is not particularly limited, as long as it allows charges in the induced flow 106 having the same polarity as the DC voltage to be preferentially supplied to the surface 104-1 of the photosensitive drum. The DC voltage can be set as appropriate to adjust the amount of charge on the photosensitive drum 104 and the contaminant 105 remaining on the surface of the photosensitive drum. From the viewpoint of controlling the charge amounts of the photosensitive drum and contaminants, it is preferable that the DC voltage be in the range of 200 V to 1500 V or −200 V to −1500 V. More preferably, it is in the range of 400 V to 1000 V or −400 V to −1000 V.

As the level of the DC voltage to be applied increases, the electric field formed between the first electrode and the photosensitive drum is intensified, so that more charges are supplied to the surface of the photosensitive drum. As a result, the charging performance with respect to the photosensitive drum and the contaminant remaining on the surface of the photosensitive drum is improved. In addition, since the direct current voltage increases the flow velocity of the induced flow, the effect of dispersing the contaminant can also be improved.

By superimposing the direct current voltage, it is also possible to bias the polarity of the charges in the induced flow, thereby charging the surface of the photosensitive drum either positively or negatively. Accordingly, the plasma actuator can be used as a charging device. In other words, a contact-type charging device such as a charging roller can be omitted. A charging device according to the present disclosure may include at least a plasma actuator and an electrophotographic photosensitive member. The DC voltage is superimposed between the first electrode of the plasma actuator and the electrophotographic photosensitive member.

### Dielectric

The dielectric is not particularly limited as long as it is made of a material having high electrical insulating properties. Examples include resins such as polyurethane resin, polyimide, polyester, fluororesin, silicone resin, acrylic resin, and phenol resin; glass; ceramics; and composite materials in which these are mixed with resins or the like. Preferably, the dielectric is a silicone resin, polyimide, or glass. For example, it is more preferable to use a material having a high volume resistivity, a chemically uniform structure with minimal localized irregularities or crystal grain boundaries, and a low dielectric constant, such as a silicone resin, since this can suppress dielectric breakdown between the first electrode and the second electrode.

It is also preferable that the dielectric is a polyurethane resin. For example, the plasma actuator may be embedded in a cleaning blade that includes an elastic member and a support member supporting the elastic member. In this case, the elastic member is made of polyurethane resin, and the plasma actuator is configured so that the polyurethane resin can serve as the dielectric. For example, the second electrode may be embedded in the elastic member, and the first electrode may be provided on the outer side of the elastic member so as to generate an induced flow in a desired direction. For example, as shown in FIG. 12, the first electrode 203 may be provided on the outer side of the elastic member serving as the cleaning member 103, and the edge of the first electrode in a direction other than the direction in which the induced flow 106 is generated may be covered with a dielectric 209. Then, the metal plate of the cleaning member 103 may be used as the second electrode 205 of the plasma actuator.

In the plasma actuator 102, as the minimum distance between the first electrode and the second electrode decreases, plasma is more easily generated. Therefore, it is preferable that the dielectric be made as thin as possible within a range that does not cause electrical dielectric breakdown, and its thickness is preferably 10 μm to 1000 μm, more preferably 10 μm to 200 μm.

### Arrangement of Plasma Actuator and Cleaning Member

In order to improve the cleaning performance of the cleaning member, it is preferable to supply an induced flow to the electrophotographic photosensitive member between the transfer member and the cleaning member. Specifically, the plasma actuator is preferably disposed upstream in the rotational direction of electrophotographic photosensitive member, as close as possible to the cleaning member, so that the induced flow is supplied to the contaminant (residual transfer toner) before it reaches the contact portion between the cleaning member and electrophotographic photosensitive member (see FIG. 1B, etc.).

Specifically, it is preferable to attach the plasma actuator to the upstream surface of the cleaning member, or to the cartridge or a component of the main body, such that the induced flow can be directed to a location immediately upstream of the cleaning member. More preferably, the cleaning member is an electrophotographic cleaning blade, and the plasma actuator is provided on a side surface of the electrophotographic cleaning blade, upstream in the rotational direction of the surface of the photosensitive drum (see FIGS. 1B and 8A).

It is also possible to provide the plasma actuator on the downstream side of the cleaning member in the rotational direction of the surface of the photosensitive drum (see FIGS. 8B and 8C). In this case, even when a contaminant electrostatically adhered to the surface of the photosensitive drum passes through the contact portion between the cleaning member and the photosensitive drum, the contaminant can be neutralized by the induced flow directed toward it, thereby weakening its electrostatic adhesion to the surface of the photosensitive drum. As a result, the contaminant that reaches the contact portion during the next rotation of the photosensitive drum can be removed by the cleaning member.

Arrangement of Plasma Actuator (PA) and Photosensitive Member (Orientation and Placement with Respect to Base Material)

The plasma actuator 102, which generates an induced flow containing charges, is positioned such that the induced flow 106 is directly supplied to the surface 104-1 of the photosensitive drum, which is a charge-receiving member, in order to improve the charging efficiency of the surface region of the photosensitive drum.

For example, it is preferable to arrange the plasma actuator and the charge-receiving member such that the induced flow 106 carrying charges is supplied to the surface of the photosensitive drum over the shortest possible distance.

It is also preferable to arrange the plasma actuator such that the surface 104-1 of the photosensitive drum is included on an extension of the direction along the exposed portion 201-1 of the first surface of the dielectric from the edge of the first electrode of the plasma actuator. It is also preferable to position the plasma actuator such that the point 701b, which will be described later, is present.

Preferably, as shown in FIG. 8A, the plasma actuator is arranged such that the surface of the photosensitive drum, which is a charge-receiving member, lies on an extension of the direction in which the induced flow is emitted. More preferably, the plasma actuator is arranged such that the direction from the first electrode to the dielectric is located opposite to the direction from the dielectric to the photosensitive drum surface, which serves as the charge-receiving member.

### Distance Between Plasma Actuator and Photosensitive Drum

The distance between the plasma actuator and the photosensitive drum may be set as appropriate according to conditions such as the output of the plasma actuator, as long as it is sufficient to neutralize or charge the contaminant. In order to more effectively supply charges in the induced flow to the surface of the photosensitive drum, it is preferable to reduce the distance between the plasma actuator and the photosensitive drum within a range in which discharge from the first electrode of the plasma actuator does not directly reach the photosensitive drum. As an example, in FIG. 8A, it is preferable to arrange the components such that the distance 701 between the tip 701a of the plasma actuator 102 on the second electrode side and the point 701b, where an extension of the direction along the exposed portion 201-1 of the first surface of the dielectric from the edge of the first electrode intersects the surface of the photosensitive drum (line 700), falls within a range of 1 mm to 20 mm (more preferably from 1 mm to 10 mm, even more preferably from 1 mm to 5 mm).

Orientation of Plasma Actuator with Respect to Rotation Direction of Photosensitive Drum

In the electrophotographic apparatus 101, the outflow direction of the induced flow 106 from the plasma actuator 102 is not particularly limited as long as it is directed toward the photosensitive drum 104. However, a preferred configuration for achieving the effects of the present disclosure will be described below.

As shown in FIG. 8A, an extension line 700 in the direction along the exposed portion 201-1 of the first surface of the dielectric from the edge of the first electrode of the plasma actuator intersects the surface of the photosensitive drum at a point 701b. A tangential vector 702 is defined as the velocity vector in the rotational direction of the photosensitive drum on the tangent to the surface of the photosensitive drum at the point 701b.

It is preferable that, when an outflow direction vector 106a of an induced flow 106 supplied from the plasma actuator 102 is decomposed, the outflow direction vector 106a has a directional component 106x that is parallel to but directed oppositely from a tangential vector 702 (hereinafter, an arrangement in which the directional component 106x is parallel to but directed oppositely from the tangential vector 702 is referred to as an arrangement of counter, and an arrangement in which the component is parallel to and directed in the same direction as the tangential vector 702 is referred to as an arrangement of with.

When the outflow direction of the induced flow is as described above, the relative velocity of the induced flow with respect to the photosensitive drum increases, allowing a stronger flow to be applied to the contaminant remaining on the surface of the photosensitive drum. As a result, the contaminant is rolled on the surface of the photosensitive drum, and the photosensitive drum and the contaminant can be more effectively neutralized and charged.

It is also acceptable that, when the outflow direction vector 106a is decomposed, the outflow direction vector 106a has a directional component that is parallel and in the same direction as the tangential vector 702 (referred to as with above). In such a case, the induced flow is less likely to be disturbed by the rotation of the photosensitive drum, and can remain in contact with the surface of the photosensitive drum and the contaminant for a longer period of time. As a result, the photosensitive drum and the contaminant can be more effectively neutralized or charged.

### Angle

The inventors have found that the residual transfer toner, which is the main component of the contaminant, has a shape close to a true sphere, and that there exists an appropriate angle for more effectively supplying the induced flow to the gap between the surface of the photosensitive drum and the contaminant. The supply of the induced flow to the gap allows the contaminant on the surface of the photosensitive drum to be rolled, and the contaminant is more easily neutralized and charged. In addition, the surface of the photosensitive drum covered by the contaminant can also be more easily neutralized or charged.

That is, an acute angle θ is formed between the extension line in the direction along the exposed portion 201-1 of the first surface of the dielectric from the edge of the first electrode, and the tangential vector 702. The acute angle θ is preferably 0° to 90°, more preferably 100 to 45°.

### Cleaning Member

The cleaning member contacts the surface of the photosensitive drum to remove toner remaining thereon after the transfer process. Any known component for use in electrophotographic apparatuses may be used, and preferred examples, without limitation, include brushes, cleaning blades, and resin sheets.

Among them, a cleaning blade composed of an elastic resin material and having a high smoothness at the tip portion of the contact portion is preferable, as it can suppress slippage of toner or other contaminants even when lightly pressed against the surface. That is, the cleaning member is preferably an electrophotographic cleaning blade including an elastic member and a support member that supports the elastic member, and configured to clean the surface of the electrophotographic photosensitive member.

Examples of the elastic member include polyurethane elastomer, ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluororubber, silicone rubber, epichlorohydrin rubber, hydrogenated NBR, and polysulfide rubber. Polyurethane elastomer is preferably used. Among polyurethane elastomers, a polyester-based polyurethane elastomer is preferably used for its excellent abrasion resistance and viscoelastic properties.

Furthermore, the dielectric of the plasma actuator may be formed using the cleaning member, and the second electrode may be embedded in the cleaning member. In this manner, the cleaning member and the plasma actuator can be more fully integrated, thereby enabling downsizing of the apparatus.

Furthermore, since the plasma actuator can also charge the surface of the photosensitive drum, the plasma actuator can also be used as a charging member.

### Process Cartridge

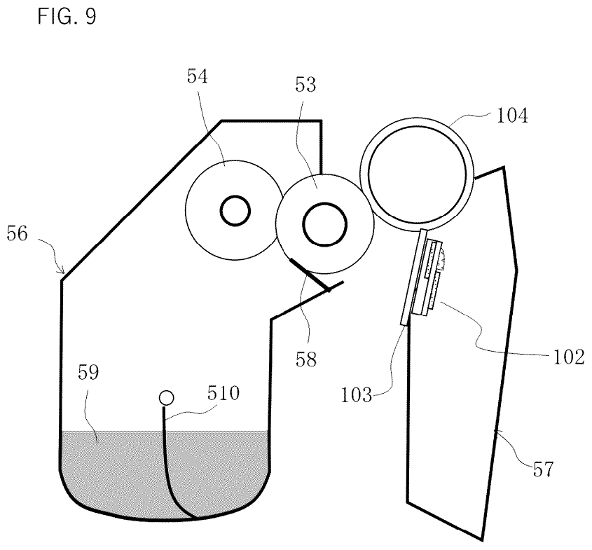

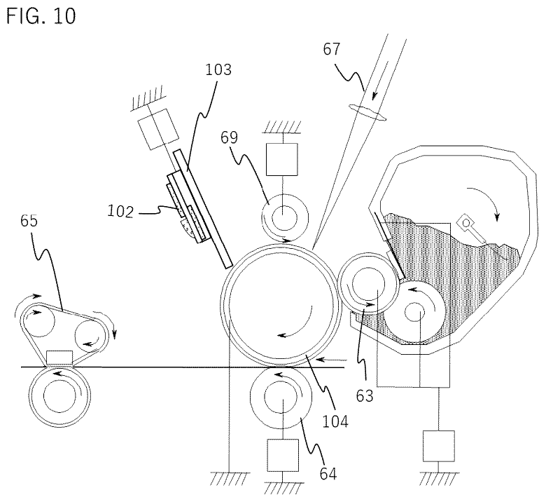

FIG. 9 is a schematic cross-sectional view of an electrophotographic process cartridge including a plasma actuator and a cleaning member. For example, the process cartridge may be detachably mounted to an electrophotographic image forming apparatus, and may include the electrophotographic photosensitive member 104, the cleaning member 103 that is in contact with the surface of the electrophotographic photosensitive member, and the plasma actuator 102.

The process cartridge may further include a developing device or a charging device. The developing device may at least integrate a developing roller 53 and a toner container 56, and may also include, as needed, a toner supply roller 54, toner 59, a developing blade 58, and a stirring blade 510. As the charging device, any known device may be used, such as one including a charging roller (not shown).

Alternatively, the process cartridge may be configured to integrate a developing unit and a charging unit, and to be detachably mountable to the main body of the electrophotographic apparatus. In this case, the charging unit may include at least an integration of the photosensitive drum 104 and the plasma actuator 102. The charging unit may further include the cleaning blade 103 and the waste toner container 57.

### Electrophotographic Image Forming Apparatus

FIG. 10 is a schematic view of the structure of an electrophotographic apparatus using a plasma actuator and a cleaning member.

The electrophotographic apparatus includes an electrophotographic photosensitive member, a charging unit configured to charge the electrophotographic photosensitive member, a latent image forming unit configured to form an electrostatic latent image by exposing the electrophotographic photosensitive member, a developing unit configured to develop the electrostatic latent image into a toner image, a transfer unit including a transfer member 64 configured to transfer the toner image onto a transfer material, a cleaning unit including a cleaning member configured to collect residual toner on the electrophotographic photosensitive member after the transfer process, and a fixing unit configured to fix the toner image on the transfer material. For example, as shown in FIG. 10, the plasma actuator 102 is provided on the cleaning member 103. The plasma actuator and the cleaning member can also be used as a charging unit of the electrophotographic apparatus.

The electrophotographic photosensitive member 104 is of a rotating drum type, and includes a photosensitive layer on a conductive substrate. The electrophotographic photosensitive member 104 is driven to rotate in the direction of the arrow at a predetermined peripheral speed (process speed). The charging apparatus includes a contact-type charging roller 69, which is arranged in contact with the electrophotographic photosensitive member 104 as a charging member. The charging member charges the electrophotographic photosensitive member 104 to a predetermined potential by applying a predetermined DC voltage from a charging power source. As a latent image forming apparatus (not shown) configured to form an electrostatic latent image on the electrophotographic photosensitive member 104, for example, an exposure apparatus such as a laser beam scanner is used. By supplying exposure light 67 corresponding to image information to the uniformly charged electrophotographic photosensitive member 104, an electrostatic latent image is formed.

The developing apparatus includes a developing sleeve or developing roller 63 disposed in proximity to or in contact with the electrophotographic photosensitive member 104. The developing apparatus forms a toner image by developing an electrostatic latent image using reversal development with toner that has been electrostatically processed to have the same polarity as the charge polarity of the electrophotographic photosensitive member 104. The transfer apparatus includes a contact-type transfer member (transfer roller) 64. The toner image is transferred from the electrophotographic photosensitive member 104 onto a transfer target medium such as plain paper. The transfer target medium is conveyed by a paper feed system having a conveying member. In the electrophotographic apparatus shown in FIG. 10, the transfer medium is, for example, paper; but if the electrophotographic apparatus includes an intermediate transfer member, the transfer target medium may be the intermediate transfer member.

The cleaning unit includes a cleaning blade 103 and an unillustrated collection container, and mechanically scrapes off and collects residual transfer toner remaining on the electrophotographic photosensitive member 104 after the developed toner image has been transferred to the transfer medium. The plasma actuator is preferably disposed upstream, in the rotational direction of the photosensitive drum, with respect to the cleaning unit. In FIG. 10, the plasma actuator 102 is provided on the cleaning blade 103, so that the induced flow can be supplied to the residual transfer toner before the toner enters the cleaning blade 103. The toner image transferred to the transfer target medium is fixed to the transfer target medium as it passes between a fixing belt 65, which is heated by a heating device (not shown), and a roller disposed opposite to the fixing belt.

The electrophotographic photosensitive member 104 serving as a charge-receiving member is not particularly limited, and a known photosensitive member used in an electrophotographic apparatus may be used. Furthermore, the toner is not particularly limited, and any known toner may be used.

### EXAMPLES

Hereinafter, the present invention will be described in more detail with reference to examples, but the present disclosure is not limited to these examples.

### Example 1

### 1. Manufacture of Plasma Actuator

An aluminum foil (length: 2.5 mm, width: 300 mm, thickness: 100 μm) was cut out from a sheet using a sharp razor and adhered with adhesive tape to a first surface of a silicone resin (with dimensions of 5 mm in height, 300 mm in width, and 150 μm in thickness) serving as the dielectric, thereby forming a first electrode. Another aluminum foil (length: 2 mm, width: 300 mm, thickness: 100 μm) was adhered with adhesive tape to a second surface of the silicone resin, so as to be diagonally opposite to the aluminum foil on the first surface, thereby forming a second electrode. Furthermore, the second surface including the second electrode was covered with a polyimide tape. In this manner, a plasma actuator was manufactured in which the first electrode and the second electrode were provided so as to overlap across the dielectric (silicone resin) with a width of 500 μm. Wires were attached to the first and second electrodes so that a voltage could be applied thereto.

Using a laser microscope, the projections along the entire longitudinal edge of the first electrode were measured, and the maximum projection height and width were found to be 21 μm and 23 μm, respectively.

### 2. Characterization

### Induced Flow Rate

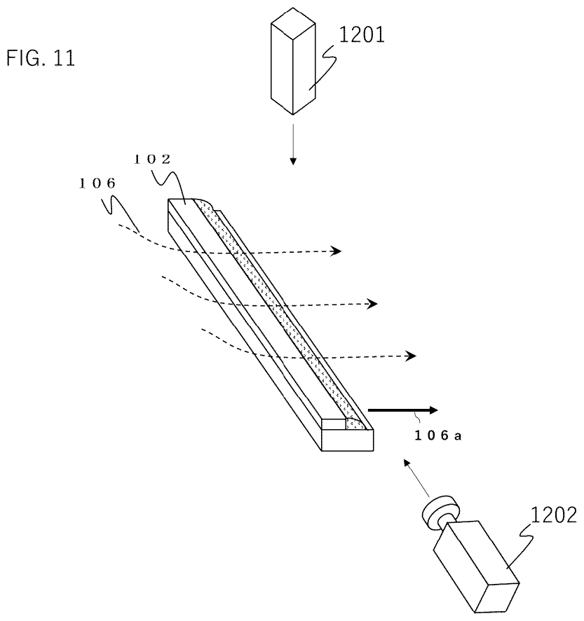

Subsequently, the velocity of the induced flow generated by the plasma actuator was measured using a particle image velocimetry (PIV) method. FIG. 11 is a schematic diagram of the PIV measurement setup.

In the PIV measurement, oil mist injected from the upstream side of a wind tunnel was visualized by a PIV Laser (Model G450, 450 mW, manufactured by Kato Koken Co., Ltd.) 1201 installed downstream of the measurement area, and images were captured by a USB high-speed camera (Model k4, manufactured by Kato Koken Co., Ltd.) 1202 installed above the measurement area.

While the manufactured plasma actuator 102 was generating an induced flow 106 in the oil mist, a rectangular wave with an amplitude of 4 kVpp and a frequency of 10 kHz was applied between the first and second electrodes of the plasma actuator, and a DC voltage of −800 V was applied between the first electrode and the ground electrode of the electrophotographic apparatus. The induced flow was then visualized and captured under this condition. The laser output was set to 450 mW, the camera aperture to F2.8, shutter speed to 1/800, and FPS to 800. The captured images were analyzed using PIV analysis software (Flow-Expert 64 ver1.3.3), and the flow velocity distribution of the induced flow was obtained by analyzing the velocity of the oil mist per unit time.

The average flow velocity of the components parallel to the outflow direction vector 106a of the induced flow 106 among the velocity vectors measured within an area of 0.2 mm×1.0 mm located 1.0 mm away from the tip position of the plasma actuator was defined as the induced flow velocity.

In Example 1, the induced flow velocity was 0.29 m/sec.

### Image Evaluation

To determine the discharge uniformity of the plasma actuator, the following evaluation was conducted.

First, a laser printer using an electrophotographic process (trade name: HP LaserJet Enterprise Color M555dn, manufactured by Hewlett-Packard) was prepared and modified to allow a prescribed voltage to be applied.

Lead wires were connected to the first and second electrodes of the plasma actuator to apply a voltage and generate an induced flow. Specifically, the apparatus was modified to apply an AC voltage from an AC power supply between the first and second electrodes, and to apply a DC voltage between the first electrode and the ground electrode of the electrophotographic apparatus.

The plasma actuator was attached to the cleaning blade of the process cartridge described above. More specifically, the plasma actuator 102 was bonded by adhering the side of the polyimide tape covering the second electrode 205. As shown in FIG. 10, the cleaning blade 103 provided with the plasma actuator 102 was disposed on the upstream side of the charging member 69 in the rotational direction of the photosensitive member.

The intrusion amount of the cleaning blade was reduced by 50%, the distance between the tip of the plasma actuator and the surface of the photosensitive drum (701 in FIG. 8A) was set to 2 mm, and the acute angle θ (shown in FIG. 8A) formed between the extension line in the direction along the exposed portion 201-1 of the first surface of the dielectric 201 and the tangential vector 702 was set to 30°.

Next, the electrophotographic apparatus and the process cartridge were left to stand for 48 hours in an environment of 18° C. and 30% RH to acclimate them to the evaluation conditions. Then, under the same environmental conditions, a halftone image was output, in which horizontal lines with a width of 1 dot (40 μm) and a spacing of 2 dots (80 μm) were drawn in a direction perpendicular to the rotational direction of the photosensitive drum. This halftone image was visually observed, and the presence of vertical streaks was evaluated according to the criteria below. In this example, the result was Rank A.

### Evaluation of Vertical Streaks in Halftone Image (Initial Image Streak Evaluation)

Rank A: No vertical streaks visible on the halftone image even under microscopic observation.
Rank B: No vertical streaks visible by the naked eye, but visible under microscopic observation.
Rank C: Vertical streaks visible in part of the halftone image by the naked eye.
Rank D: Vertical streaks visible across the entire halftone image by the naked eye.

### Neutralization Performance for Contaminants

The contaminant neutralization performance by the plasma actuator 1 was evaluated.

The neutralization performance for contaminant (residual transfer toner) was evaluated by measuring the charge amount of the residual transfer toner before and after being exposed to the induced flow generated by the plasma actuator, using a charge amount distribution measuring apparatus in the manner which will be described below.

First, in the above-described electrophotographic laser printer equipped with a plasma actuator, the amount of residual transfer toner was increased by increasing the transfer current. In determining the change in the charging polarity of the residual transfer toner, the amount of residual transfer toner used as a reference was controlled by adjusting the transfer bias such that the coverage value obtained by the measurement method described below became 5%. Specifically, the coverage value was measured as follows. First, the printing operation was stopped during the printing of a solid black image, and the residual transfer toner adhering to the area on the surface of the photosensitive drum between the contact portion of the transfer member and the contact portion of the charging member was peeled off using tape (product name: CT18, manufactured by Nichiban Co., Ltd.) and adhered to a sheet of printing paper. Then, the reflectance of the area where the residual transfer toner adhered was measured using a reflection densitometer (product name: TC-6DS/A, manufactured by Tokyo Denshoku Co., Ltd.), and the reduction in reflectance (%) relative to the reflectance of the portion of the tape where no toner adhered was determined as the coverage value.

The change in the charge amount of the residual transfer toner by the induced flow was measured as follows.

Since it was necessary to measure the change in the charge distribution caused by the induced flow from the plasma actuator when performing the measurement, the edge of the cleaning member was cut off so that the residual transfer toner completely passed through the cleaning member, with the arrangement of the cleaning member and the plasma actuator maintained, and the charge distribution was measured.

Under the same conditions as in the above [measurement of induced flow velocity], the plasma actuator was driven to allow the toner to pass through the plasma actuator, and the charge distribution after the irradiation by the induced flow was measured to determine the proportion X₁ of the residual transfer toner charged with the same polarity as the voltage applied to the transfer member.

Subsequently, the plasma actuator was turned off, and the residual transfer toner was passed through the plasma actuator again, after which the charge distribution was measured to determine the proportion X₂ of the residual transfer toner charged with the same polarity as the voltage applied to the transfer member.

For the measurement, an E-spart analyzer (manufactured by Hosokawa Micron Corp.) was used. The E-spart analyzer is an apparatus for measuring particle size and charge amount by introducing sample particles into a detection unit (measurement unit) in which an electric field and an acoustic field are formed at the same time, and measuring the moving speed of the particles by a laser Doppler method.

The measurement was conducted under the following conditions: the airflow for sample suction was 400 L/min, the voltage applied to the electrodes of the measurement section was 100 V, and the number of counts was 300 particles.

The proportion X¹ of the residual transfer toner charged with the same polarity (polarity A) as that applied to the transfer member when the plasma actuator was driven, and the proportion X₂ of the toner charged with polarity A when the plasma actuator was not driven, were determined, and the rate of change Δ was calculated using the formula: Δ=((X₂−X₁)/X₂)×100.

In the example, the proportion X of positively charged residual transfer toner within the charge distribution of the residual transfer toner obtained through measurement was calculated. The proportion of positively charged residual transfer toner when the plasma actuator was driven was defined as X₁, and that when the plasma actuator was not driven was defined as X₂. The rate of change Δ was then calculated as Δ=((X₂−X₁)/X₂)×100. The evaluation results are shown in Table 2.

Note that the average particle diameter of the toner in terms of number can also be measured using a precision particle size distribution analyzer based on the pore electrical resistance method, such as the “Coulter Counter Multisizer 3” (registered trademark, manufactured by Beckman Coulter) equipped with a 100 μm aperture tube. The measurement conditions and data analysis can be performed using the dedicated software “Beckman Coulter Multisizer 3 Version 3.51” (manufactured by Beckman Coulter) that comes with the instrument.

Evaluation of Image Streaks and Contamination Resistance after Durability Test.

After performing the evaluation of vertical streaks on the initial image described above, a total of 100,000 images were continuously output under the same conditions. The output image was designed such that the letter “E” in 4-point size was formed on A4-size paper with a print coverage of 1.0%. Then, a halftone image was output, in which horizontal lines, each having a width of one dot in the direction perpendicular to the rotation direction of the photosensitive drum and spaced at intervals of two dots, were drawn. This halftone image was visually observed and evaluated on the basis of the same evaluation criteria used for the vertical streaks in the initial image. In Example 1, the result was ranked as A.

### Contaminant Adhered to Streak Area

Among the vertical streaks generated in the contamination resistance evaluation test, the discharge portion of the charging member corresponding to the streak with the greatest density difference from the surrounding area was photographed using a laser microscope (product name: VK-8700 Color 3D Laser Microscope, manufactured by Keyence), and the number of adhered contaminants (toner) was counted. The observation was made within a field of view of 1000 μm (vertical)×1000 μm (horizontal), and the number of adhered toner particles was counted. In this example, no distinct streaks were observed; therefore, the number of adhered particles was counted at locations where contamination was observed on the surface of the charging member in the longitudinal direction. The number of adhered contaminants was 10.

### Evaluation of Dielectric Breakdown

After performing the above durability test, the first electrode of the plasma actuator 102 was visually inspected to determine whether dielectric breakdown had occurred between the two electrodes, and the number of such breakdown locations was counted. Specifically, dielectric breakdown is considered to have occurred if “burn marks” caused by dielectric breakdown are observed at the interface between the first electrode and the dielectric or at the interface between the second electrode and the dielectric. In Example 1, no dielectric breakdown occurred.

### Example 2

A process cartridge identical to that in Example 1 was prepared and evaluated, except that the cleaning member was changed to a resin sheet (ABS resin sheet; 300 mm wide, 20 mm high, 1 mm thick). The evaluation results are shown in Table 2.

### Example 3

A process cartridge identical to that in Example 1 was prepared and evaluated, except that the cleaning member was changed to a brush (300 mm wide, 280 mm long in the portion contacting the surface of the photosensitive drum, 4 mm wide in the rotational direction of the photosensitive drum, bristles 15 mm long and 30 μm thick, made of resin such as nylon or rayon, density of 250,000 bristles/inch², average contact load in the longitudinal direction: 300 gf). The evaluation results are shown in Table 2.

### Example 4

Instead of attaching the plasma actuator to the cleaning member, an ABS sheet was attached to the frame of the cartridge so that the plasma actuator could be placed in the following position. Specifically, as shown in FIG. 1A, the induced flow was irradiated at a position 5 mm upstream (in the rotational direction of the photosensitive drum) from the cleaning blade. Except for installing the plasma actuator in a configuration matching the layout in Table 1, a process cartridge was prepared in the same manner as in Example 1 and evaluated. The evaluation results are shown in Table 2.

### Examples 5 to 25

Process cartridges were prepared and evaluated in the same manner as in Example 1, except that the overlap amount of the electrodes of the plasma actuator, the height and width of the largest protrusion, the DC voltage, the placement angle, and the dielectric material were changed as shown in Table 1. The evaluation results are shown in Table 2.

In Example 25, a polyimide resin sheet was used as the dielectric material.

In Examples 9 to 12, a protrusion was formed at the edge of the first electrode (which generates discharge) by grinding cut-out aluminum foil with sandpaper to create an uneven surface.

In Examples 19 to 23, although the narrow angle θ was changed, the angle at which the cleaning blade comes into contact remained unchanged by adjusting the attachment angle of the plasma actuator using an ABS base material.

### Example 26

As shown in FIG. 12, a process cartridge was prepared and evaluated in the same manner as in Example 1, except that the second electrode 205 of the plasma actuator was formed using a metal plate serving as the support member for the cleaning blade, and that an insulating ABS sheet 209 was attached onto the first electrode to prevent the induced flow from being generated on the metal plate side. The evaluation results are shown in Table 2.

### Example 27

A process cartridge was prepared and evaluated in the same manner as in Example 1, except that the charging member of the process cartridge was removed and the plasma actuator was configured as the charging member. The evaluation results are shown in Table 2.

### Example 28

A process cartridge was prepared and evaluated in the same manner as in Example 1, except that the first and second electrodes of the plasma actuator were not overlapped and were spaced apart by a distance of 200 μm. The evaluation results are shown in Table 2. In this example, since the two electrodes were not overlapped, the induced flow generated by the plasma actuator was relatively weak, resulting in a relatively weak effect of neutralizing and/or charging the residual toner after transfer compared to Example 1. This have probably caused the occurrence of streak images after the durability test. The evaluation results are shown in Table 2.

### Comparative Example 1

A process cartridge was prepared and evaluated in the same manner as in Example 1, except that the plasma actuator was not used. The evaluation results are shown in Table 2. In this comparative example, since the plasma actuator did not perform neutralization or scattering of the contaminants, the contaminants passed through the contact portion of the cleaning blade, resulting in streak-like contamination of the charging member. The evaluation results are shown in Table 2.

### Comparative Example 2

A process cartridge was evaluated in the same manner as in Example 1, except that the cleaning blade was modified to include a conductive portion for performing charging, and the charging member was removed. Specifically, a conductive surface was formed by metal vapor deposition on the surface of the cleaning blade facing the photosensitive drum, and a lead wire was connected to this conductive surface so that a DC voltage (−1000 V) could be applied. This configuration enabled simultaneous cleaning and charging. The evaluation results are shown in Table 2. In this comparative example, since the plasma actuator did not perform neutralization or dispersing of the contaminants, the contaminants passed through the contact portion of the cleaning blade, resulting in streak-like contamination of the charging member. The evaluation results are shown in Table 2.

### Comparative Example 3

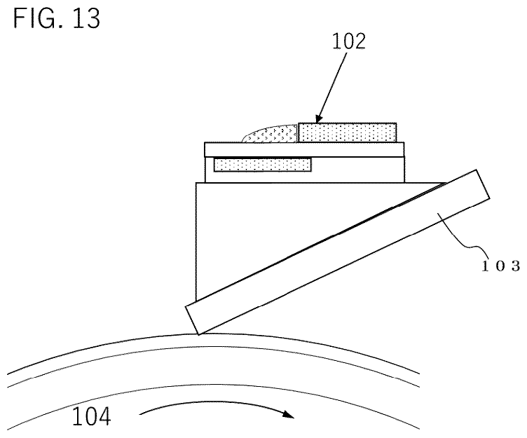

As shown in FIG. 13, except that the plasma actuator was arranged such that the plane of the upper cross-section of the first electrode was perpendicular to the diametric direction of the photosensitive drum, a process cartridge was manufactured and evaluated in the same manner as in Example 1. The plasma actuator was provided separately from the cleaning blade on an ABS base material so that the angle of the cleaning blade remained unchanged. The evaluation results are shown in Table 2. In this comparative example, the induced flow generated by the plasma actuator was not directly directed to the surface of the photosensitive drum. Therefore, it is considered that no charge neutralization and/or charging effect on the residual toner was achieved. The evaluation results are shown in Table 2.

TABLE 1

| | | | Method for | Electrode arrangement | | | DC | | | | Material |
|---|---|---|---|---|---|---|---|---|---|---|---|
| | | | installing | Overlap | Protrusion | | voltage | | | | of |
| | Corresponding | Cleaning | plasma | length A | height/width | | Vdc | | | Acute | dielectric |
| | cross section | member | actuator | (μm) | (μm) | | (V) | Arrangement | | Angle | Layer |
| Example 1 | 8A | Cleaning | Attached to | 500 | 21 | 23 | −800 | Counter | Upstream | 30 | Silicone |
| | | blade | cleaning blade | | | | | | | | |
| Example 2 | 8A | Resin | Attached to | 500 | 22 | 22 | −800 | Counter | Upstream | 30 | Silicone |
| | | sheet | cleaning | | | | | | | | |
| | | | member | | | | | | | | |
| Example 3 | 8A | Brush | Attached to | 500 | 21 | 20 | −800 | Counter | Upstream | 30 | Silicone |
| | | | cleaning | | | | | | | | |
| | | | member | | | | | | | | |
| Example 4 | 8A | Cleaning | Discrete | 500 | 20 | 21 | −800 | Counter | Upstream | 30 | Silicone |
| | | blade | | | | | | | | | |
| Example 5 | 8A | Cleaning | Attached to | 0 | 21 | 19 | −800 | Counter | Upstream | 30 | Silicone |
| | | blade | cleaning blade | | | | | | | | |
| Example 6 | 8A | Cleaning | Attached to | 100 | 20 | 22 | −800 | Counter | Upstream | 30 | Silicone |
| | | blade | cleaning blade | | | | | | | | |
| Example 7 | 8A | Cleaning | Attached to | 1000 | 21 | 21 | −800 | Counter | Upstream | 30 | Silicone |
| | | blade | cleaning blade | | | | | | | | |
| Example 8 | 8A | Cleaning | Attached to | 1200 | 22 | 21 | −800 | Counter | Upstream | 30 | Silicone |
| | | blade | cleaning blade | | | | | | | | |
| Example 9 | 8A | Cleaning | Attached to | 500 | 41 | 38 | −800 | Counter | Upstream | 30 | Silicone |
| | | blade | cleaning blade | | | | | | | | |
| Example 10 | 8A | Cleaning | Attached to | 500 | 40 | 98 | −800 | Counter | Upstream | 30 | Silicone |
| | | blade | cleaning blade | | | | | | | | |
| Example 11 | 8A | Cleaning | Attached to | 100 | 42 | 95 | −800 | Counter | Upstream | 30 | Silicone |
| | | blade | cleaning blade | | | | | | | | |
| Example 12 | 8A | Cleaning | Attached to | 500 | 59 | 38 | −800 | Counter | Upstream | 30 | Silicone |
| | | blade | cleaning blade | | | | | | | | |
| Example 13 | 8A | Cleaning | Attached to | 500 | 21 | 21 | −500 | Counter | Upstream | 30 | Silicone |
| | | blade | cleaning blade | | | | | | | | |
| Example 14 | 8A | Cleaning | Attached to | 500 | 20 | 22 | −300 | Counter | Upstream | 30 | Silicone |
| | | blade | cleaning blade | | | | | | | | |
| Example 15 | 8A | Cleaning | Attached to | 500 | 21 | 20 | 0 | Counter | Upstream | 30 | Silicone |
| | | blade | cleaning blade | | | | | | | | |
| Example 16 | 8D | Cleaning | Attached to | 500 | 20 | 20 | −800 | With | Upstream | 30 | Silicone |
| | | blade | cleaning blade | | | | | | | | |
| Example 17 | 8B | Cleaning | Attached to | 500 | 22 | 21 | −800 | Counter | Downstream | 30 | Silicone |
| | | blade | cleaning blade | | | | | | | | |
| Example 18 | 8C | Cleaning | Attached to | 500 | 21 | 20 | −800 | With | Downstream | 30 | Silicone |
| | | blade | cleaning blade | | | | | | | | |
| Example 19 | 8A | Cleaning | Attached to | 500 | 22 | 22 | −800 | Counter | Upstream | 0 | Silicone |
| | | blade | cleaning blade | | | | | | | | |
| Example 20 | 8A | Cleaning | Attached to | 500 | 20 | 20 | −800 | Counter | Upstream | 20 | Silicone |
| | | blade | cleaning blade | | | | | | | | |
| Example 21 | 8A | Cleaning | Attached to | 500 | 20 | 19 | −800 | Counter | Upstream | 40 | Silicone |
| | | blade | cleaning blade | | | | | | | | |
| Example 22 | 8A | Cleaning | Attached to | 500 | 21 | 20 | −800 | Counter | Upstream | 60 | Silicone |
| | | blade | cleaning blade | | | | | | | | |
| Example 23 | 8A | Cleaning | Attached to | 500 | 20 | 21 | −800 | Counter | Upstream | 80 | Silicone |
| | | blade | cleaning blade | | | | | | | | |
| Example 24 | 8A | Cleaning | Attached to | 500 | 22 | 22 | −800 | Counter | Upstream | 30 | Glass |
| | | blade | cleaning blade | | | | | | | | |
| Example 25 | 8A | Cleaning | Attached to | 500 | 20 | 22 | −800 | Counter | Upstream | 30 | Polyimide |
| | | blade | cleaning blade | | | | | | | | |
| Example 26 | — | Cleaning | Incorporated | 500 | 22 | 20 | −800 | Counter | Upstream | 30 | Urethane |
| | | blade | | | | | | | | | |
| Example 27 | 8A | Cleaning | Attached to | 500 | 21 | 23 | −900 | Counter | Upstream | 30 | Silicone |
| | | blade | cleaning blade | | | | | | | | |
| Example 28 | 8A | Cleaning | Attached to | −200 | 21 | 22 | −800 | Counter | Upstream | 30 | Silicone |
| | | blade | cleaning blade | | | | | | | | |
| Comparative | — | Cleaning | None | — | — | — | — | — | — | — | — |
| Example 1 | | blade | | | | | | | | | |
| Comparative | — | Cleaning | None | — | — | — | — | — | — | — | — |
| Example 2 | | blade | | | | | | | | | |
| | | with | | | | | | | | | |
| | | conductive | | | | | | | | | |
| | | portion | | | | | | | | | |
| Comparative | — | Cleaning | ABS | 500 | 20 | 22 | −800 | Counter | Upstream | — | Silicone |
| Example 3 | | blade | substrate | | | | | | | | |

In the table, upstream in “arrangement” indicates that the plasma actuator was arranged on the upstream side in the rotational direction of the photosensitive drum relative to the cleaning member (see FIGS. 8A and 8D). In contrast, “downstream” indicates that the plasma actuator was arranged on the downstream side in the rotational direction of the photosensitive drum relative to the cleaning member (see FIGS. 8B and 8C).

TABLE 2

| | | | | | Initial | After | | |
|---|---|---|---|---|---|---|---|---|
| | | | | | image | durability test | | |
| | | | | | Streaked | Streaked | | |
| | Induced | Neutralization | | | image | image | Contaminant | Dielectric |
| | flow | performance | | | evaluation | evaluation | Number of | break down |
| | velocity | X1 | X2 | Δ | rank | rank | adhered | Number |
| | m/sec | (%) | (%) | (%) | (A-D) | (A-D) | particles | counted |
| Example 1 | 0.29 | 4.89 | 61.1 | 92 | A | A | 10 | 0 |
| Example 2 | 0.29 | 2.49 | 62.3 | 96 | A | C | 58 | 0 |
| Example 3 | 0.29 | 3.04 | 60.9 | 95 | A | C | 62 | 0 |
| Example 4 | 0.29 | 3.05 | 61.0 | 95 | A | B | 34 | 0 |
| Example 5 | 0.25 | 11.7 | 61.4 | 81 | A | B | 33 | 0 |
| Example 6 | 0.28 | 5.61 | 62.3 | 91 | A | A | 15 | 0 |
| Example 7 | 0.27 | 17.4 | 60.1 | 71 | A | B | 25 | 0 |
| Example 8 | 0.15 | 28.9 | 60.3 | 52 | A | B | 33 | 0 |
| Example 9 | 0.28 | 3.13 | 62.6 | 95 | A | A | 5 | 0 |
| Example 10 | 0.29 | 3.62 | 60.4 | 94 | B | B | 8 | 0 |
| Example 11 | 0.29 | 2.40 | 60.1 | 96 | C | C | 7 | 0 |
| Example 12 | 0.29 | 3.61 | 60.1 | 94 | C | C | 5 | 0 |
| Example 13 | 0.25 | 11.0 | 61.2 | 82 | A | B | 21 | 0 |
| Example 14 | 0.21 | 22.5 | 60.9 | 63 | A | C | 31 | 0 |
| Example 15 | 0.16 | 27.5 | 61.0 | 55 | A | B | 45 | 0 |
| Example 16 | 0.29 | 11.2 | 62.3 | 82 | A | B | 22 | 0 |
| Example 17 | 0.29 | 11.7 | 61.8 | 81 | A | B | 32 | 0 |
| Example 18 | 0.29 | 10.6 | 62.5 | 83 | A | B | 45 | 0 |
| Example 19 | 0.29 | 4.85 | 60.7 | 92 | A | B | 31 | 0 |
| Example 20 | 0.29 | 2.46 | 61.5 | 96 | A | A | 12 | 0 |
| Example 21 | 0.29 | 2.46 | 61.4 | 96 | A | A | 15 | 0 |
| Example 22 | 0.29 | 7.29 | 60.8 | 88 | A | B | 25 | 0 |
| Example 23 | 0.29 | 22.2 | 61.5 | 64 | A | C | 55 | 0 |
| Example 24 | 0.29 | 2.52 | 63.1 | 96 | A | A | 11 | 0 |
| Example 25 | 0.29 | 3.05 | 61.1 | 95 | A | A | 12 | 0 |
| Example 26 | 0.25 | 11.8 | 61.9 | 81 | A | B | 25 | 0 |
| Example 27 | 0.35 | 4.98 | 62.2 | 92 | A | A | 10 | 0 |
| Example 28 | 0.05 | 57.0 | 63.3 | 10 | A | C | 90 | 0 |
| Comparative | — | — | — | — | A | D | 210 | — |
| Example 1 | | | | | | | | |
| Comparative | — | — | — | — | A | D | 230 | — |
| Example 2 | | | | | | | | |
| Comparative | 0.29 | 60.9 | 60.9 | 0 | A | D | 330 | 0 |
| Example 3 | | | | | | | | |

According to at least one aspect of the present disclosure, an electrophotographic image forming apparatus is provided that exhibits stably excellent cleaning performance on the surface of the electrophotographic photosensitive member over a long period. Also, according to at least one aspect of the present disclosure, a process cartridge can be obtained that can exhibit excellent cleaning performance on the surface of the photosensitive drum over a long period of time.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic image forming apparatus comprising:
an electrophotographic photosensitive member serving as a charge-receiving member; a cleaning member in contact with a surface of the electrophotographic photosensitive member; and a plasma actuator,
the plasma actuator comprising:
a dielectric;
a first electrode provided on a first surface of the dielectric; and
a second electrode provided opposed to the first electrode across the dielectric;
application of an AC voltage between the first and second electrodes causing the plasma actuator to generate an induced flow from an edge of the first electrode along an exposed portion of the first surface of the dielectric, the exposed portion being a portion not covered with the first electrode,
the plasma actuator being disposed to be capable of directly supplying the induced flow to the surface of the electrophotographic photosensitive member to control a potential of residual transfer toner on the surface of the electrophotographic photosensitive member.

2. The electrophotographic image forming apparatus according to claim 1, wherein the control of the potential of the residual transfer toner comprises at least one selected from the group consisting of:
neutralizing the residual transfer toner by the induced flow, and
charging the residual transfer toner by the induced flow to a polarity identical to that of the surface of the electrophotographic photosensitive member.

3. The electrophotographic image forming apparatus according to claim 1, wherein the control of the potential of the residual transfer toner is performed before the residual transfer toner enters a contact portion between the cleaning member and the electrophotographic photosensitive member.

4. The electrophotographic image forming apparatus according to claim 1, wherein the cleaning member is an electrophotographic cleaning blade having an elastic member and a support member that supports the elastic member and configured to clean a surface of the electrophotographic photosensitive member.

5. The electrophotographic image forming apparatus according to claim 1, wherein the plasma actuator is disposed on a surface of the cleaning member.

6. The electrophotographic image forming apparatus according to claim 1, wherein when the plasma actuator is viewed from a surface side of the first electrode,
at least a portion of the edge of the first electrode has an overlap portion overlapping with the second electrode, and
a length A between the edge of the first electrode and the edge of the second electrode that forms the overlap portion is 0 μm to 1000 μm.

7. The electrophotographic image forming apparatus according to claim 1, wherein the first electrode and the second electrode are offset obliquely from each other across the dielectric.

8. The electrophotographic image forming apparatus according to claim 1, wherein the edge of the first electrode has a maximum protrusion having a length of 0 μm to 40 μm and a width of 0 μm to 40 μm.

9. The electrophotographic image forming apparatus according to claim 1, wherein the plasma actuator directly supplies the induced flow further toward an upstream side in a rotational direction of the electrophotographic photosensitive member than a contact portion between the cleaning member and the electrophotographic photosensitive member.

10. The electrophotographic image forming apparatus according to claim 1, wherein a point at which an extension line from the edge of the first electrode in a direction along the exposed portion of the first surface of the dielectric intersects a surface of the electrophotographic photosensitive member is defined, and a tangential vector, which is a velocity vector in the rotational direction of the electrophotographic photosensitive member on a tangent to the surface of the electrophotographic photosensitive member at the point, is defined, and
when a vector representing an outflow direction of the induced flow supplied from the plasma actuator is decomposed, the outflow direction vector has a directional component that is parallel to and in the same direction as the tangential vector.

11. The electrophotographic image forming apparatus according to claim 1, wherein a point at which an extension of a direction along the exposed portion of the first surface of the dielectric from the edge of the first electrode intersects the surface of the electrophotographic photosensitive member is defined, and
a tangential vector, which is defined as a velocity vector in the rotational direction of the electrophotographic photosensitive member on a tangent to the surface of the electrophotographic photosensitive member at the point, is defined and
when a vector representing an outflow direction of the induced flow supplied from the plasma actuator is decomposed, the outflow direction vector has a directional component parallel to and in the opposite direction to the tangential vector.

12. The electrophotographic image forming apparatus according to claim 1, wherein a point at which an extension line in a direction along the exposed portion of the first surface of the dielectric from the edge of the first electrode intersects the surface of the electrophotographic photosensitive member is defined, and a tangential vector, which is defined as a velocity vector in the rotational direction of the electrophotographic photosensitive member on a tangent to the surface of the electrophotographic photosensitive member at the point is defined, and
when an acute angle formed between the extension line in the direction along the exposed portion of the first surface of the dielectric from the edge of the first electrode and the tangential vector is defined as an acute angle θ, the acute angle θ is 0° to 90°.

13. The electrophotographic image forming apparatus according to claim 12, wherein the acute angle θ is 100 to 45°.

14. The electrophotographic image forming apparatus according to claim 4, wherein the second electrode of the plasma actuator is the support member of the electrophotographic cleaning blade.

15. The electrophotographic image forming apparatus according to claim 1, wherein the dielectric of the plasma actuator comprises a polyurethane resin.

16. The electrophotographic image forming apparatus according to claim 1, wherein the induced flow has a velocity of 0.15 m/sec to 1.00 m/sec at a position 1.0 mm away from a front end of a supply direction of the induced flow in the plasma actuator, the velocity being measured by a particle image velocimetry method.

17. The electrophotographic image forming apparatus according to claim 1, wherein the electrophotographic image forming apparatus applies a DC voltage between the first electrode of the plasma actuator and the electrophotographic photosensitive member.

18. A process cartridge removably mountable to an electrophotographic image forming apparatus, the process cartridge comprising:
an electrophotographic photosensitive member; a cleaning member in contact with a surface of the electrophotographic photosensitive member; and a plasma actuator,
the plasma actuator comprising:
a dielectric;
a first electrode provided on a first surface of the dielectric; and
a second electrode provided opposed to the first electrode across the dielectric,
application of an AC voltage between the first and second electrodes causing the plasma actuator to generate an induced flow from an edge of the first electrode along an exposed portion of the first surface of the dielectric, the exposed portion being a portion not covered with the first electrode,
the plasma actuator being disposed to be capable of directly supplying the induced flow to the surface of the electrophotographic photosensitive member to control a potential of residual transfer toner on the surface of the electrophotographic photosensitive member.

19. The process cartridge according to claim 18, wherein the control of the potential of the residual transfer toner comprises at least one selected from the group consisting of:
neutralizing the residual transfer toner by the induced flow, and
charging the residual transfer toner by the induced flow to a polarity identical to that of the surface of the electrophotographic photosensitive member.

20. The process cartridge of claim 18, wherein the first electrode and the second electrode are offset obliquely from each other across the dielectric.
